(19) United States
(12) Patent Application Publication
(10) Pub. No.: US 2008/0313710 A1
(43) Pub. Date: Dec. 18, 2008

(54) COMMUNICATIONS DEVICE, COMMUNICATIONS METHOD, COMMUNICATIONS PROGRAM, AND COMPUTER-READABLE STORAGE MEDIUM STORING THE COMMUNICATIONS PROGRAM

(76) Inventors: Atsuhiro Doi, Tenri-shi (JP); Fumihiro Fukae, Sakurai-shi (JP); Hitoshi Naoe, Kitakatsuragi-gun (JP); Minehiro Konya, Osaka (JP); Kenji Mameda, Kashihara-shi (JP); Mitsunori Nojima, Kashiba-shi (JP)

Correspondence Address: BIRCH STEWART KOLASCH & BIRCH, PO BOX 747, FALLS CHURCH, VA, 22040-0747, US

(21) Appl. No.: 12/139,302

(22) Filed: Jun. 13, 2008

(30) Foreign Application Priority Data
Jun. 15, 2007 (JP) 2007-159538

(51) Int. Cl. H04L 9/32; G06F 15/16

(52) U.S. Cl. 726/3

(57) ABSTRACT

The communications device of the present invention performs an authentication with the device at the other end automatically or through a simple operation, independently of an authentication scheme supported by the device at the other end. A communications device includes: a connecting section for establishing a connection with the other communications device according to the IrSimple scheme; an authentication section for performing an authentication by the IrSimple scheme; a connecting section for establishing a connection with the other communications device according to the IrDA scheme, an authentication section for performing an authentication according to the IrDA scheme; and a protocol switching section for causing the connecting section to initiate a connection and causing the authentication section to perform an authentication, when an authentication by the authentication section is unsuccessful. This makes it possible to switch to a protocol of the IrDA scheme and perform communications according to the IrDA scheme when the other communications device does not support device authentication of the IrSimple scheme although being compliant with the IrSimple scheme.

This Nonprovisional application claims priority under 35 U.S.C. §119(a) on Patent Application No. 159538/2007 filed in Japan on Jun. 15, 2007, the entire contents of which are hereby incorporated by reference.

### FIELD OF THE INVENTION

The present invention relates to a communications device, a communications method, a communications program, and a computer-readable storage medium storing the communications program, all of which perform authentication at information exchange.

### BACKGROUND OF THE INVENTION

Currently, communications devices such as portable phones and PDAs are widely used. Especially, the so-called information terminal devices have been increasingly popular. The information terminal device has a telephonic communications capability, a capability of keeping telephone book data and schedule data, and other capabilities. Some of such communications devices also have the capability of transmitting/receiving (performing object exchange) telephone book data and schedule data which are kept by a portable phone or any other communications device.

Such communications devices having an object exchange capability include communications devices which perform authentication on whether or not data transfer is permitted. The authentication is performed before data transfer by, for example, entering the same numerals in both communications devices at transmitting and receiving ends (hereinafter, the authentication is referred to as device authentication). As a result, even in a case where one communications device transmits a data transfer request by wireless communications such as infrared communications and a plurality of other communications devices receive the data transfer request, the device authentication as above makes it possible to identify a device to communicate. This enables one-to-one data transfer between a user and the party whom the user intends.

Patent Document 1 (Japanese Unexamined Patent Publication 2005-244483 (Tokukai 2005-244483)) discloses the art such that, on the basis of the result of determination as to whether data transfer is performed by wired or wireless communications, secret information for use in authentication is selected from either secret information stored in advance in a communications device or newly entered secret information, so that the authentication is performed using the secret information thus selected.

Recently, a growing number of mobile communications devices, such as portable phones and PDAs, which have the object exchange capability including such authentication have been capable of performing infrared communications.

One of such communications schemes utilizing infrared light is the IrDA (Infrared Data Association) scheme. A communications protocol of the IrDA scheme (hereinafter referred to as IrDA communications protocol) has a stack structure including layers corresponding to respective functions. Communications control is performed in each layer. The IrDA scheme is broadly composed of a physical layer and a communications layer. The physical layer controls transmission speed, transmission distance, etc. The communications layer is divided into sub-layers according to the capability of communications. That is, the communications layer is composed of an IrLAP layer for controlling a communications data link, an IrLMP layer for performing link management, a TTP layer for performing flow control, an OBEX layer for performing object transfer, and the like.

The IrDA scheme is widely employed for portable phones etc. However, the IrDA scheme has a problem that data transfer is very slow. That is, for example, the IrDA scheme takes a few seconds to complete a connection because, at the initiation of communications, one device searches for a target device to communicate, and after identifying the target device, each layer of the one device is connected to a corresponding layer of the target device to communicate.

In view of the problem, the IrSimple scheme has been recently developed as a communications scheme which enables high-speed communications utilizing infrared light. The IrSimple scheme is a communications scheme that is an IrDA-based higher-level protocol. According to a communications protocol of the IrSimple scheme (hereinafter referred to as IrSimple communications protocol), the physical layer and the OBEX layer are the same as those of the IrDA communications protocol. The IrLAP layer, the IrLMP layer, and the TTP layer, which are the layers of the IrDA scheme, are replaced with or arranged in parallel with an IrSimple-IrLAP layer, an IrSimple-IrLMP layer, and an IrSMP layer, respectively.

The IrSimple scheme has two profiles (one-way/two-way communications). The one-way communications are communications in which data is transferred in only one direction. That is, the one-way communications are such that a transmitter only transmits data to the receiver without requiring communications from a receiver, and the receiver only receives data without responding to the transmitter. On the other hand, the two-way communications are the communications as in the conventional IrDA scheme.

Both the transmitter and the receiver have a compatible mode between an IrDA device and an IrSimple device and have the following function. That is, at the establishment of connection, a device at one end determines whether a communications scheme is the IrDA scheme or the IrSimple scheme according to a response from a device at the other end and automatically switches from one connection sequence to the other connection sequence in accordance with the communications scheme thus determined. The authentication is performed through the two-way communication.

For the infrared data communications, there are two types of device authentication operations: One is an authentication operation based on the IrDA communications protocol (hereinafter referred to as IrDA authentication operation), and the other is an authentication operation based on the IrSimple communications protocol (hereinafter referred to as IrSimple authentication operation). The following describes each of the authentication operations in detail.

FIG. 13 is a sequence diagram illustrating one example of a basic sequence including the IrSimple authentication operation.

Both IrDA communications and IrSimple communications are performed by transmitting/receiving a frame, which is a unit of data and contains every piece of data to be transmitted to each layer. Among such pieces of data, data required for the device authentication is controlled in the OBEX layer.

In FIG. 13,

(1) Upon initiation of the IrSimple authentication operation, a transmitter transmits to a receiver an SNRM (Set Normal Response Mode) frame, which is a connection request frame for requesting the initiation of communications. The SNRM frame contains a CONNECT command and an Authentication Challenge object (connection request+request for authentication connection). The CONNECT command is a command to request a communications connection to the OBEX layer. The Authentication Challenge object is an object for requesting the initiation of authentication.

(2) In a case where the receiver supports the IrSimple authentication operation, the receiver generates another Authentication Challenge object based on a terminal-specific value such as a manufacturing number, and transmits to the transmitter a UA (Unnumbered Acknowledgement) frame, which is a connection response frame that indicates the acceptance of the initiation of communications. The UA frame contains an UNAUTHORIZED response and the Authentication Challenge object thus generated (connection response+authentication request). The UNAUTHORIZED response is a response for notifying the OBEX layer of the incompletion of authentication.

(3) Upon receiving the authentication request from the receiver, the transmitter prompts a user A who operates the transmitter to enter a password. Upon receiving the password entered by the user A, the transmitter generates, based on the authentication request thus received and the password thus entered by the user A, an Authentication Response object, which is an object for notifying the receiver of authentication response. The transmitter then transmits to the receiver a UI (Unnumbered Information) frame, which is a data transfer frame. The UI frame contains the Authentication Response object to the OBEX layer (authentication response).

(4) Upon receiving the authentication response, the receiver prompts a user B who operates the receiver to enter a password. Upon receiving the password entered by the user B, the receiver compares the authentication response thus received with the password thus entered by the user B so as to determine whether or not the authentication is successful. When the authentication is determined to be successful, the receiver transmits to the transmitter, utilizing the UI frame, a SUCCESS response, which is a response to notify the OBEX layer of success of the authentication (authentication result response). The authentication is thus completed and then object exchange is initiated.

(5) The OBEX layer at the transmitter transmits data to the receiver, utilizing the UI frame. Upon completion of data transmission, the receiver transmits to the transmitter, utilizing the UI frame, a SUCCESS response, which is a response to notify the OBEX layer the completion of data reception.

(6) Upon completion of the object exchange, the transmitter transmits to the receiver a DISC (Disconnect) frame, which is a disconnection request frame for requesting the termination of communications. The DISC frame contains a DISCONNECT command, which is a command to request communications disconnection from the OBEX layer (disconnection request).

(7) Upon receiving the disconnection request, the receiver transmits to the transmitter a UA frame, which is a disconnection response frame that indicates the acceptance of the termination of communications. The UA frame contains a SUCCESS response, which is a response to notify the OBEX layer of the acceptance of disconnection of communications (disconnection response).

A series of operations including the IrSimple authentication operation are thus completed.

FIG. 14 is a sequence diagram illustrating one example of a basic sequence including the IrDA authentication operation.

The IrDA communications are completely the same as the IrSimple communications with respect to how data required for the device authentication is handled in the OBEX layer. However, there is a significant difference between the IrDA communications and the IrSimple communications in a connection sequence before the initiation of data transfer in the OBEX layer and a disconnection sequence after the completion of data transfer.

In FIG. 14,

(1) Upon initiation of the IrDA authentication operation, a transmitter transmits to a receiver an XID-CMD (exchange station identification-Command) frame, which is a device discovery frame for searching for a device to communicate (device discovery).

(2) The receiver transmits to the transmitter an XID-RSP (exchange station identification-Response) frame, which is a device discovery response frame for the transmitter to recognize the receiver (device discovery response).

(3) The transmitter transmits to the receiver an XID-END (exchange station identification-End) frame, which is a device discovery end frame (end of device discovery). The transmitter then transmits an SNRM frame for requesting the initiation of connection (IrLAP connection request).

(4) The receiver transmits to the transmitter a UA frame that indicates the acceptance of the initiation of connection (IrLAP connection response). In response to the UA frame, the transmitter transmits to the receiver an I (Information) frame, which is a data transfer frame, in order to request the IrLMP layer and the TTP layer for communications connection. The I frame contains a CONNECT command, which is a command to request communications connection to each of the IrLMP layer and the TTP layer (IrLMP connection request+TTP connection request).

(5) In the IrLMP layer, the receiver transmits to the transmitter, utilizing the I frame, a CONNECT response, which is a communications connection response (IrLMP connection response).

(6) In order to request the OBEX layer for communications connection, the transmitter transmits to the OBEX layer of the receiver, utilizing the I frame, a CONNECT command and an Authentication Challenge object (request for authentication connection).

(7) According to a terminal-specific value such as a manufacturing number, the receiver generates another Authentication Challenge object. The receiver then transmits to the OBEX layer of the transmitter, utilizing the I frame, an UNAUTHORIZED response and the Authentication Challenge object thus generated (authentication request).

(8) Upon receiving the authentication request from the receiver, the transmitter prompts a user A who operates the transmitter to enter a password. Upon receiving the password entered by the user A, the transmitter generates an Authentication Response object based on the authentication request thus received and the password thus entered by the user A. The transmitter transmits the Authentication Response object thus generated to the OBEX layer of the receiver, utilizing the I frame (authentication response).

(9) Upon receiving the authentication response, the receiver prompts a user B who operates the receiver to enter a password. Upon receiving the password entered by the user B, the receiver compares the authentication response thus received with the password thus entered by the user B so as to determine whether or not the authentication is successful. When the authentication is determined to be successful, the receiver transmits a SUCCESS response to the OBEX layer of the transmitter, utilizing the I frame. The authentication is thus completed and then object exchange is initiated.

(10) In the OBEX layer, the transmitter transmits data to the receiver, utilizing the I frame. Upon completion of data transfer, the receiver transmits to the transmitter, utilizing the I frame, a SUCCESS response to notify the OBEX layer of the completion of data transfer.

(11) Upon completion of the object exchange, in the OBEX layer, the transmitter transmits a DISCONNECT command to the receiver, utilizing the I frame, in order to request communications disconnection of the OBEX layer (OBEX disconnection request).

(12) In the OBEX layer, the receiver transmits to the receiver, utilizing the I frame, a SUCCESS response that indicates the acceptance of the communications disconnection (OBEX disconnection response).

(13) In order to request the communications disconnection of the IrLMP layer, the transmitter transmits in the IrLMP layer a DISCONNECT command to the receiver, utilizing the I frame, which DISCONNECT command is a command to request communications disconnection (IrLMP disconnection request).

(14) The transmitter transmits to the receiver a DISC frame for requesting the termination of communications (IrLAP disconnection request).

(15) The receiver transmits to the transmitter a UA frame that indicates the acceptance of the termination of communications (disconnection response).

A series of operations including the IrDA authentication operation are thus completed.
[Patent Document 1]

Japanese Unexamined Patent Publication No. 2005-244483 (Tokukai 2005-244483; published on Sep. 8, 2005)
[Patent Document 2]

International publication No. 2006/013979 pamphlet (published on Feb. 9, 2006)
[Patent Document 3]

International publication No. 2006/080357 pamphlet (published on Aug. 3, 2006)
[Non-patent Document 1]

Infrared Data Association Serial Infrared Link Access Protocol (IrLAP) Version 1.1 (Jun. 16, 1996)
[Non-patent Document 2]

Infrared Data Association Serial Infrared Link Management Protocol (IrLMP) Version 1.1 (Jan. 23, 1996)
[Non-patent Document 3]

Infrared Data Association ‘Tiny TP’: A Flow-Control Mechanism for use with IrLMP Version 1.1 (Oct. 20, 1996)
[Non-patent Document 4]

Infrared Data Association Object Exchange Protocol Version 1.3 (Jan. 3, 2003)
[Non-patent Document 5]

Infrared Data Association IrLAP Fast Connect (Application Note) Version 1.0 (Nov. 27, 2002)
[Non-patent Document 6]

IrDA Serial Infrared Link Access Protocol Specification for IrSimple Addition Version 1.0 (Oct. 14, 2005)
[Non-patent Document 7]

IrDA Serial Infrared Link Management Protocol Specification for IrSimple Addition Version 1.0 (Oct. 14, 2005)
[Non-patent Document 8]

IrDA Serial Infrared Sequence Management Protocol for IrSimple Version 1.0 (Oct. 14, 2005)
[Non-patent Document 9]

Infrared Data Association Serial Infrared Physical Layer Specification Version 1.4 (May 30, 2001)

However, the conventional art has the following problem. That is, in some cases, a receiver cannot perform data transfer involving the IrSimple device authentication, depending on whether or not the device authentication is supported by the receiver, even if the receiver are IrDA and IrSimple compliant. This is described below in detail.

Assume that a transmitter performs data transfer involving the IrSimple device authentication. In this case, if the receiver does not support the IrSimple device authentication although being IrDA and IrSimple compliant, the transmitter determines that the authentication is unsuccessful. Therefore, the transmitter disconnects the communications. As a result, data transfer of the IrSimple scheme cannot be performed.

FIG. 15 is a sequence diagram illustrating one example of a basic sequence in a case where the receiver does not support the IrSimple authentication operation although being IrSimple compliant.

In FIG. 15,

(1) Upon initiation of the IrSimple authentication, the OBEX layer at the transmitter transmits to the receiver, a CONNECT command and an Authentication Challenge object utilizing an SNRM frame (connection request+request for authentication connection).

(2) In a case where the receiver does not support the IrSimple authentication operation although being IrSimple compliant, the OBEX layer at the receiver transmits to the transmitter, utilizing a UA frame, a SUCCESS response that indicates the acceptance of a connection without authentication (connection response).

(3) Upon receiving the connection response, the transmitter determines that the authentication is unsuccessful because the transmitter receives acceptance of a connection without authentication request although the transmitter has requested authentication. The transmitter then disconnects the communications with the receiver because the connection therebetween without authentication has been established. That is, the OBEX layer at the transmitter transmits to the receiver, utilizing a DISC frame, a DISCONNECT command for requesting the termination of communications (disconnection request).

(4) Upon receiving the disconnection request, the OBEX layer at the receiver transmits to the transmitter, utilizing a UA frame, a SUCCESS response that indicates the acceptance of the termination of communications (disconnection response). Depending on a receiver, the OBEX layer transmits to the transmitter an INTERNAL SERVER ERROR response to notify that the disconnection request is unreasonable. This occurs when the receiver has not actually entered into a connection with the transmitter although the receiver has transmitted the SUCCESS response to the transmitter in the connection response in (2). The receiver transmits to the transmitter the INTERNAL SERVER ERROR because the receiver has received the disconnection request in spite of being in unconnected state.

Upon initiation of the IrSimple authentication operation by the transmitter, an IrDA/IrSimple compatible mode of the IrSimple scheme, which allows two-way communications, functions when a receiver is only IrDA compliant. This allows the transmitter to automatically perform switching to the IrDA authentication operation.

However, in a case where the receiver does not support the IrSimple authentication operation although being IrSimple compliant, the conventional arrangement above prioritize a connection of the IrSimple scheme over a connection of the IrDA scheme because the receiver is IrSimple compliant. Therefore, a connection of the IrSimple scheme is established. As a result, the IrDA authentication operation is not performed.

In such a case, data transfer can be successful at the second attempt if a user instructs the transmitter to perform data transfer involving the IrDA device authentication. However, in the conventional arrangement, this is impossible because it is difficult for a user to identify the cause of an authentication failure and a user is required to perform additional complicated operations. In addition, there has not been provided a function of switching automatically or without interruption to data transfer involving the IrDA device authentication when authentication is unsuccessful in a case where the receiver does not support the IrSimple authentication operation although being IrSimple compliant.

### SUMMARY OF THE INVENTION

The present invention has been attained in view of the problem, and an object of the present invention is to realize (i) a communications device, (ii) a communications method, (iii) a communications program, and (iv) a computer-readable storage medium storing the communications program, all of which make it possible to perform authentication with the other device automatically or by a simple operation, independently of an authentication scheme supported by the device at the other end.

In order to attain the object, a communications device of the present invention is a communications device which performs communications in accordance with a communications protocol involving an authentication process, including: a first connecting section for establishing a connection with a device at the other end in accordance with a first protocol; a first authentication section for performing an authentication with the device at the other end through a process supported by the first protocol; a second connecting section for establishing a connection with the device at the other end in accordance with a second protocol, which is different from the first protocol; a second authentication section for performing an authentication with the device at the other end through a process supported by the second protocol; and a protocol switching section for causing the second connecting section to initiate a connection and then causing the second authentication section to perform an authentication, when an authentication by the first authentication section is unsuccessful.

A communications method of the present invention is a communications method of a communications device which performs communications in accordance with a communications protocol involving an authentication process, including: a first authentication step of performing an authentication with a device at the other end through a process supported by a first protocol, after a connection with the device at the other end is initiated in accordance with the first protocol; a second connecting step of initiating a connection with the device at the other end in accordance with a second protocol, which is different from the first protocol, when an authentication by the first authentication step is unsuccessful; and a second authentication step of performing an authentication with the device at the other end through a process supported by the second protocol.

According to the arrangement, when the communications device established a connection with the other communications device in accordance with the first protocol and failed in an authentication with the other communications device, the communications device initiates a connection with the other communications device in accordance with the second protocol, which is different from the first protocol, and performs an authentication with the other communications device through a process supported by the second protocol.

Therefore, even if a device authentication in accordance with the first protocol is unsuccessful, the communications device can make an attempt to perform another device authentication in accordance with the second protocol, by switching the first protocol to the second protocol. For example, assume that a communications device supporting the IrSimple scheme as the first protocol and the IrDA scheme as the second protocol performs data transfer to the other communications device. In this case, even if the other communications device does not support a device authentication of the IrSimple scheme although being IrSimple and IrDA compliant, the communications device can perform communications with the other communications device by switching the protocol of the IrSimple scheme to the protocol of the IrDA scheme.

This enables a user of the communications device to exchange information with the other communications device, independently of an authentication scheme supported by the other communications device. This makes it possible to simplify a user operation for exchanging information and to improve convenience of communications.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a functional block diagram illustrating detailed arrangements of a communications device of an embodiment of the present invention and a communications system including the communications device.

FIG. 2 is a block diagram schematically illustrating an arrangement of the communications system, which is composed of the communications device illustrated in FIG. 1 and a communications device at the other end to communicate.

FIG. 3 is a flowchart illustrating operations of the communications device when performing data transmission involving authentication in accordance with a communications protocol of the IrSimple scheme.

FIG. 4 is a sequence diagram illustrating one example of a basic sequence including an authentication process in accordance with the communications protocol of the IrSimple scheme.

FIG. 5 is a flowchart illustrating operations of the communications device when performing data transmission involving authentication in accordance with a communications protocol of the IrDA scheme.

FIG. 6 is a sequence diagram illustrating one example of a basic sequence including an authentication process in accordance with the communications protocol of the IrDA scheme.

FIG. 7 is a flowchart illustrating operations of the communications device of FIG. 1 and processes for automatically switching to the IrDA scheme when the communications device has failed in device authentication of the IrSimple scheme.

FIG. 8 is a flowchart illustrating operations of the communications device of FIG. 1 and processes for switching to the IrDA scheme by instruction from a user when the communications device has failed in device authentication of the IrSimple scheme.

FIG. 9 is a sequence diagram illustrating one example of a basic sequence in which a transmitter determines that a receiver supports an authentication operation of the IrSimple scheme.

FIG. 10 is an explanatory diagram illustrating one example of a data format of an UNAUTHORIZED response to an OBEX layer.

FIG. 11 is a sequence diagram illustrating one example of a basic sequence in which the transmitter determines that the receiver does not support the authentication operation of the IrSimple scheme although being IrSimple compliant.

FIG. 12 is an explanatory diagram illustrating one example of a data format of a SUCCESS response to the OBEX layer.

FIG. 13 is a sequence diagram illustrating a conventional art and one example of a basic sequence including an authentication process of the IrSimple scheme.

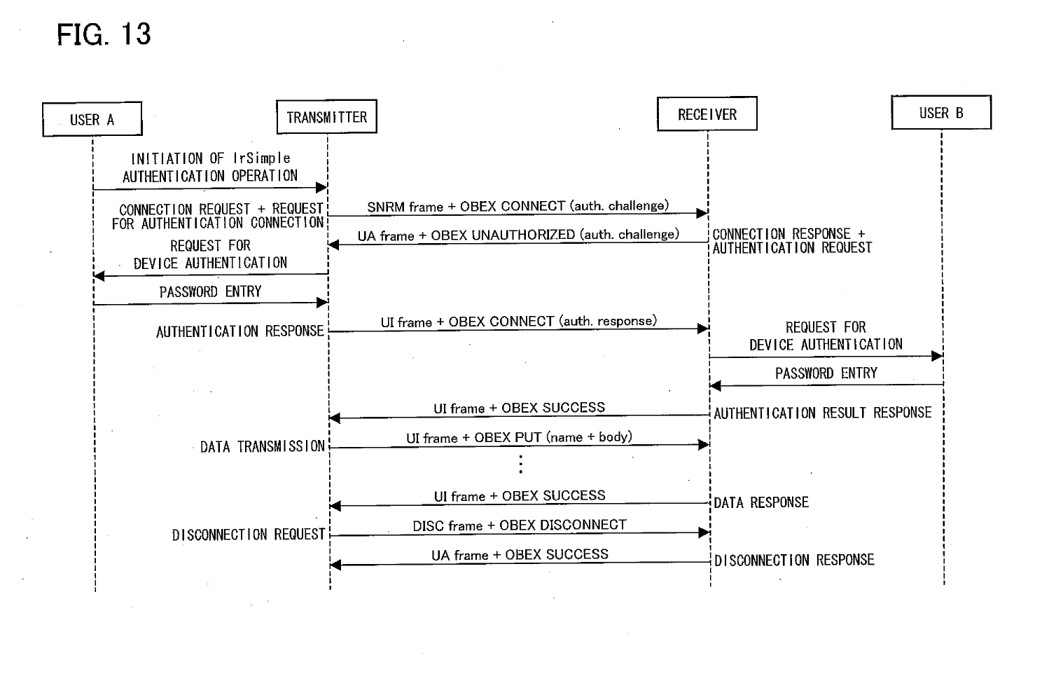

FIG. 14 is a sequence diagram illustrating a conventional art and one example of a basic sequence including an authentication process of the IrDA scheme.

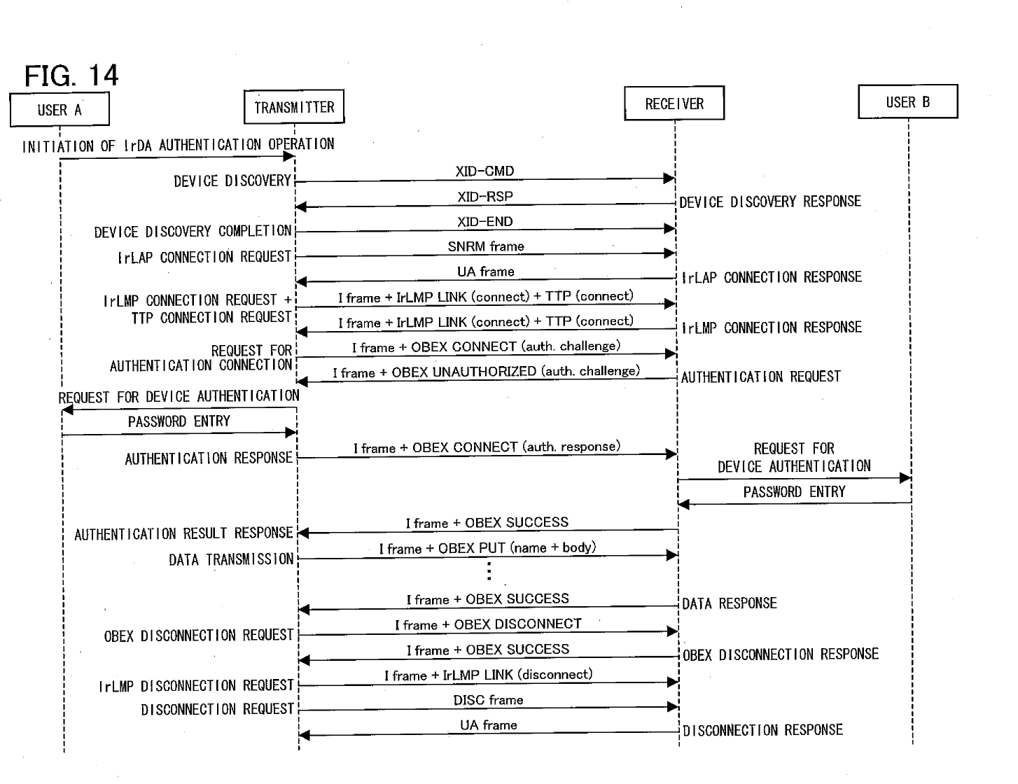

FIG. 15 is a sequence diagram illustrating a conventional art and one example of a basic sequence in a case where the receiver does not support the authentication operation of the IrSimple scheme although being IrSimple compliant.

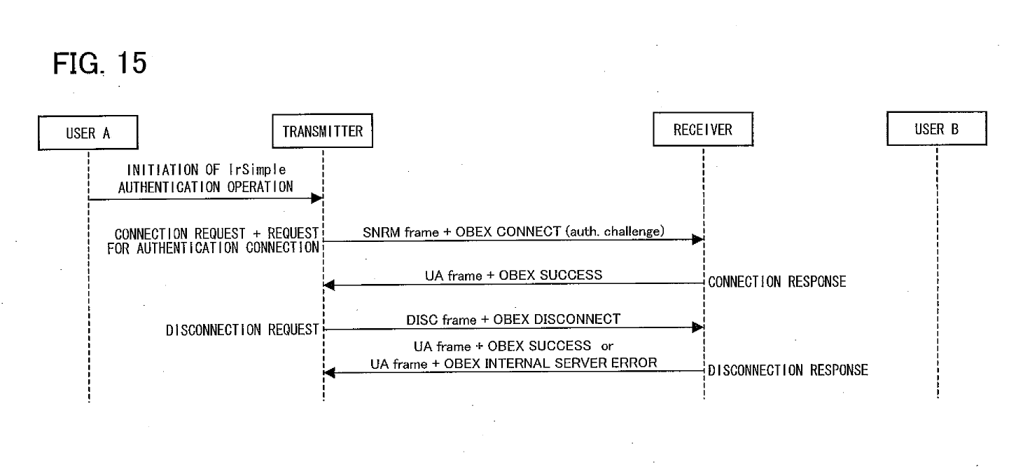

### DESCRIPTION OF THE EMBODIMENTS

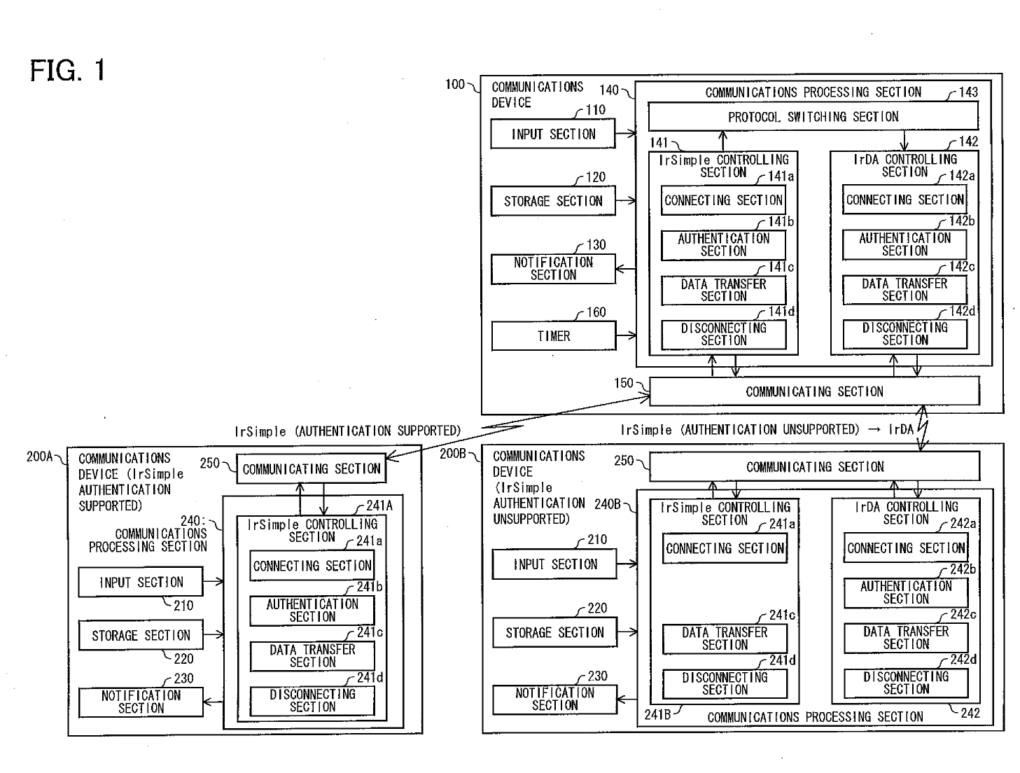

The following describes one embodiment of the present invention with reference to FIGS. 1 to 12.

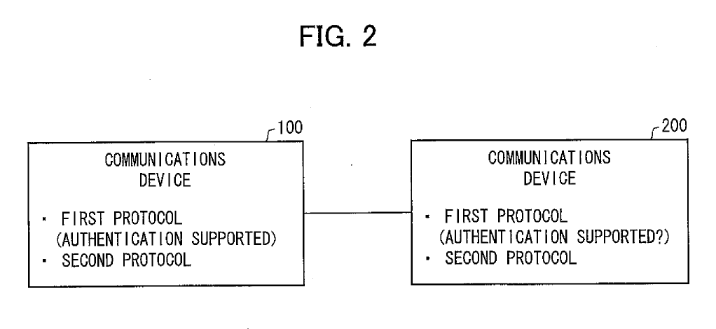

FIG. 2 is a block diagram schematically illustrating an arrangement of a communications system, which is composed of a communications device 100 of the present embodiment and a communications device 200, which is a device to communicate with the communications device 100.

The communications device 100 includes at least a first protocol for initially attempting a connection and a second protocol for attempting the next connection. The communications device 100 performs authentication in the course of establishing a connection in accordance with the first protocol. When the communications device 200 is compliant with the first protocol, the communications device 100 establishes a connection in accordance with the first protocol. On the other hand, when the communications device 200 does not support a device authentication of the first protocol although being compliant with the first protocol, the communications device 100 disconnects the connection in accordance with the first protocol and then establishes a connection in accordance with the second protocol.

Assume that, in FIG. 2, the communications device 100 and the communications device 200 are portable phones, for example. Each of the communications devices transmits its own data such as telephone book data and schedule data to a device at the other end by wireless (infrared communication, Bluetooth, etc.) or wired (USB, IEEE1394, LAN, etc.) communications, and writes data received by wireless or wired communications in its own internal memory.

In the present embodiment, the following description assumes that the first protocol and the second protocol are the IrSimple scheme and the IrDA scheme, respectively. However, types of these two protocols and combination of the two protocols are not limited to this. That is, the present invention is suitably applicable to a communications system in which a simpler communications scheme (the first protocol) and a more complicated (requiring more connection procedures) communications scheme (the second protocol) are defined. For example, when a transmitter attempts communications by an authentication scheme defined in a simpler (requiring fewer connection procedures) connection scheme and receives no authentication response from a receiver, the transmitter performs a disconnection process. The transmitter then switches to a more complicated communication scheme. Alternatively, the transmitter indicates an error on a display, waits for instruction from the user, and switches to the more complicated communication scheme according to the instruction from the user. Thus, it is possible to improve convenience of communications with an object exchange function requiring authentication.

FIG. 1 is a functional block diagram illustrating detailed arrangements of the communications device 100 of the present embodiment and the communications device 200, which is a device to communicate with the communications device 100. FIG. 1 shows an example in which the IrSimple scheme and the IrDA scheme are employed as the first and the second protocols, respectively. Any two protocols as described above may be selected as the first and the second protocols.

The communications device 100 performs communications in accordance with a communications protocol involving an authentication process. Specifically, the communications device 100 initiates a connection with the communications device 200, which is the device at the other end to communicate, according to the IrSimple scheme (the first protocol). Then, the communications device 100 performs the following steps: a first authentication step; a second connection step; and a second authentication step. The first authentication step is a step of performing authentication with the communications device 200 through a process supported by the IrSimple scheme. The second connecting step is a step of, at the failure of the authentication in the first authentication step, establishing a connection with the communications device 200 according to the IrDA scheme (the second protocol), which is different from the IrSimple scheme. The second authentication step is a step of performing authentication with the communications device 200 through a process supported by the IrDA scheme.

As illustrated in FIG. 1, the communications device 100 includes an input section 110, a storage section 120, a notification section 130, a communications processing section 140, a communicating section 150, and a timer 160. In the present embodiment, communications of the IrSimple scheme and the IRDA scheme are two-way communications.

The input section 110 is realized by a keyboard, a touch panel, a microphone that receives audio input, or the like. The input section 110 accepts an operation of a user. The input section 110 is used for, for example, entering secret information such as a password for authentication.

The storage section 120 is realized by a memory such as a RAM and a ROM, a hard disk drive, or the like. The storage section 120 stores data of a telephone book, schedule data, various other items of data, a program, secret information such as a password for authentication, and the like. A password for use in authentication may be four-digit numeral. Alternatively, according to a system change etc., the password may be changed to non-four-digit numeral, alphanumeric, or the like.

Under control of the communications processing section 140, the notification section 130 notifies information such as a result of an authentication operation, through display, voice announcement, and/or the like. The notification section 130 is a liquid crystal display, an organic EL display, a head-mounted display, which are apparatuses for visually notifying information, a speaker, which is a device for aurally notifying information, a vibration generator, which is a device for tactually notifying information, and/or the like. These apparatuses/devices may be used singly or in combination with each other.

The communicating section 150 transmits and receives by a wireless or wired method information to be exchanged with the communications device 200. The communicating section 150 is a device for transmitting information by wireless or wired communications. The communicating section 150 may be a device utilizing infrared communication, Bluetooth®, wireless LAN compliant with IEEE802.11b standard etc., dedicated short range communication, or the like. Alternatively, the communicating section 150 may be a device utilizing Universal Serial Bus (USB), RS232C, IEEE1394, a wired LAN, or the like.

The timer 160 is used to determine a timing of data transmission. Specifically, when the communications device 100 fails in the IrSimple authentication, the communications device 100 (i) waits for longer than a time limit (link disconnect time) within which the communications device 200 maintains a connection when there is no response from the communications device 100, (ii) disconnects a connection of the IrSimple scheme, and then (iii) initiates a connection of the IrDA scheme. In this case, a protocol switching section 143 generates a trigger for the initiation of the IrDA authentication, based on a measurement time of the timer 160.

The communications processing section (communications processing means) 140 is provided with two protocols so as to perform communications of the IrSimple scheme (hereinafter referred to as IrSimple communications) and communications of the IrDA scheme (hereinafter referred to as IrDA communications). When the IrSimple authentication is unsuccessful, the communications processing section 140 switches the IrSimple protocol to the IrDA protocol. In establishing a connection in accordance with either of the protocols, the communications processing section 140 performs authentication, based on secret information such as a password entered through the input section 110. The functions of the communications processing section 140 are realized by a processing unit, such as a CPU, performing the operations in accordance with a program stored in the storage section 120.

The communications processing section 140 includes an IrSimple controlling section (first protocol controlling means) 141, an IrDA controlling section (second protocol controlling means) 142, and a protocol switching section (protocol switching means) 143. The communications processing section 140 mainly controls a protocol in a LAP layer.

The IrSimple controlling section 141 performs communications in accordance with the IrSimple protocol. In order to perform the communications in accordance with the IrSimple protocol, the IrSimple controlling section 141 includes a connecting section (first connecting means) 141a, an authentication section (first authentication means) 141b, a data transfer section (first data transfer means) 141c, and a disconnecting section (first disconnecting means) 141d. The IrSimple controlling section 141 (i) causes the connecting section 141a to perform a connection process when establishing a connection, (ii) causes the data transfer section 141c to perform data transfer when transferring data, and (iii) causes the disconnecting section 141d to perform a disconnection process when disconnecting a connection.

The connecting section 141a establishes a connection with the communications device 200 according to the IrSimple scheme.

The authentication section 141b performs authentication with the communications device 200 through a process supported by the IrSimple scheme, which is used for the connecting section 141a to establish a connection. When the authentication section 141b receives “connection response+authentication request” in response to “connection request+request for authentication connection,” the authentication section 141b determines that the communications device 200 supports the IrSimple authentication operation. Conversely, when the authentication section 141b receives “connection response,” the authentication section 141b determines that the communications device 200 does not support the IrSimple authentication operation. The authentication section 141b then notifies the protocol switching section 143 a result of the determination.

The data transfer section 141c performs data transfer in accordance with the IrSimple scheme.

The disconnecting section 141d performs a disconnection process in accordance with the IrSimple scheme. Specifically, the disconnecting section 141d disconnects a connection of the IrSimple scheme, the connection established by the connecting section 141a. The disconnecting section 141d disconnects the connection of the IrSimple scheme by transmitting to the communications device 200 a request for disconnecting the IrSimple communications. Alternatively, the disconnecting section 141d disconnects the IrSimple connection by not responding to the communications device 200 for longer than the time limit within which the communications device 200 maintains communications when the communications device 100 does not respond to the communications device 200.

The IrDA controlling section 142 performs communications in accordance with the IrDA protocol. In order to perform the communications in accordance with the IrDA protocol, the IrDA controlling section 142 includes a connecting section (second connecting means) 142a, an authentication section (second authentication means) 142b, a data transfer section (second data transfer means) 142c, and a disconnecting section (second disconnecting means) 142d. The IrDA controlling section 142 (i) causes the connecting section 142a to perform a connection process when establishing a connection, (ii) causes the data transfer section 142c to perform data transfer when transferring data, and (iii) causes the disconnecting section 142d to perform a disconnection process when disconnecting a connection.

The connecting section 142a establishes a connection with the communications device 200 according to the IrDA scheme.

The authentication section 142b performs authentication with the communications device 200 through a process supported by the IrDA scheme, which is used for the connecting section 142a to establish a connection.

The data transfer section 142c performs data transfer according to the IrDA scheme.

The connecting section 142d performs a disconnection process according to the IrDA scheme.

When the authentication section 141b fails in an attempt of the IrSimple authentication, the protocol switching section 143 causes the connecting section 142a to initiate the IrDA connection and causes the authentication section 142b to perform the IrDA authentication. When the authentication section 141b fails in an attempt of the IrSimple authentication, the protocol switching section 143 causes the disconnecting section 141d to disconnect the IrSimple connection before causing the connecting section 142a to initiate the IrDA connection. After causing the disconnecting section 141d to disconnect the IrSimple connection, the protocol switching section 143 may obtain via the input section 110 a user's input indicative of permission of the IrDA communications and then cause the connecting section 142a to initiate the IrDA connection. The protocol switching section 143 may make a notification for prompting user's entry via the notification section 130.

The following describes the communications device 200. The communications device 200 is a device to communicate with the communications device 100. The communications device 200 is provided with the IrSimple or IrDA protocol.

As illustrated in FIG. 1, a communications device 200A is an example of a communications device being IrSimple compliant and supporting the IrSimple authentication. Specifically, in the communications device 200A, a communications processing section 240A includes an IrSimple controlling section 241A. The communications device 200A performs communications in accordance with the IrSimple protocol. In order to perform communications in accordance with the IrSimple protocol, the IrSimple controlling section 241A includes a connecting section 241a, an authentication section 241b, a data transfer section 241c, and a disconnecting section 241d. The IrSimple controlling section 241A (i) causes the connecting section 241a to perform a connection process when establishing a connection, (ii) causes the data transfer section 241c to perform data transfer when transferring data, and (iii) causes the disconnecting section 241d to perform a disconnection process when disconnecting a connection. Particularly, the communications device 200A includes the authentication section 241b and supports authentication of the IrSimple scheme.

The communications device 200A may be provided with the IrDA protocol. In the present embodiment, however, since the communications device 100 initially attempts the IrSimple connection and the communications device 200A includes the authentication section 241b, the IrSimple connection is established between the communications devices 100 and 200A. Therefore, even if the IrDA protocol is provided in the communications device 200A, the IrDA protocol is not used unless the user explicitly selects the IrDA protocol.

As illustrated in FIG. 1, the communications device 200B is an example of a communications device not supporting the IrSimple authentication although being IrSimple IrDA compliant. Specifically, in the communications device 200B, a communications processing section 240B includes an IrSimple controlling section 241B for performing the IrSimple communication and an IrDA controlling section 242 for performing the IrDA communications.

The IrSimple controlling section 241B includes a connecting section 241a, a data transfer section 241c, and a disconnecting section 241d. The IrSimple controlling section 241B (i) causes the connecting section 241a to perform a connection process when establishing a connection, (ii) causes the data transfer section 241c to perform data transfer when transferring data, and (iii) causes the disconnecting section 241d to perform a disconnection process when disconnecting a connection. In this respect, the communication device 200B is the same as the communications device 200A. However, the communications device 200B does not include an authentication section and does not support the IrSimple authentication.

The IrDA controlling section 242 includes a connecting section 242a, an authentication section 242b, a data transfer section 242c, and a disconnecting section 242d. The IrDA controlling section 242 (i) causes the connecting section 242a to perform a connection process when establishing a connection, (ii) causes the data transfer section 242b to perform data transfer when transferring data, and (iii) causes the disconnecting section 242c to perform a disconnection process when disconnecting a connection. Particularly, the communications device 200B includes the authentication section 242b and supports the IrDA authentication.

In the present embodiment, when the communications device 100 initially has attempted to establish the IrSimple connection and failed in the IrSimple authentication, the communications device 100 establishes the IrDA connection. Therefore, although the communications device 100 attempts to establish the IrSimple connection with the communications device 200B, the communications device 100 fails in the IrSimple authentication because the communications device 200B does not include an authentication section. As a result, the IrDA connection is established therebetween.

The communications devices 100 and 200 may include more protocols such as a third protocol and a fourth protocol so as to switch to the next protocol when the communications device 100 or 200 has attempted to establish a connection and failed in authentication.

[Prerequisite Art]

In order to describe operation of the communications device 100 of the present embodiment, the following describes a prerequisite art.

First, with reference to FIGS. 3, 4, and 2, the following describes the operation of the communications device 100 which operation is performed only in accordance with the IrSimple communications protocol (first protocol). This operation is basically the same as the operation performed in accordance with the conventional IrSimple communications protocol. As for the arrangement of the communications device 100, FIG. 1 is referred to as necessary.

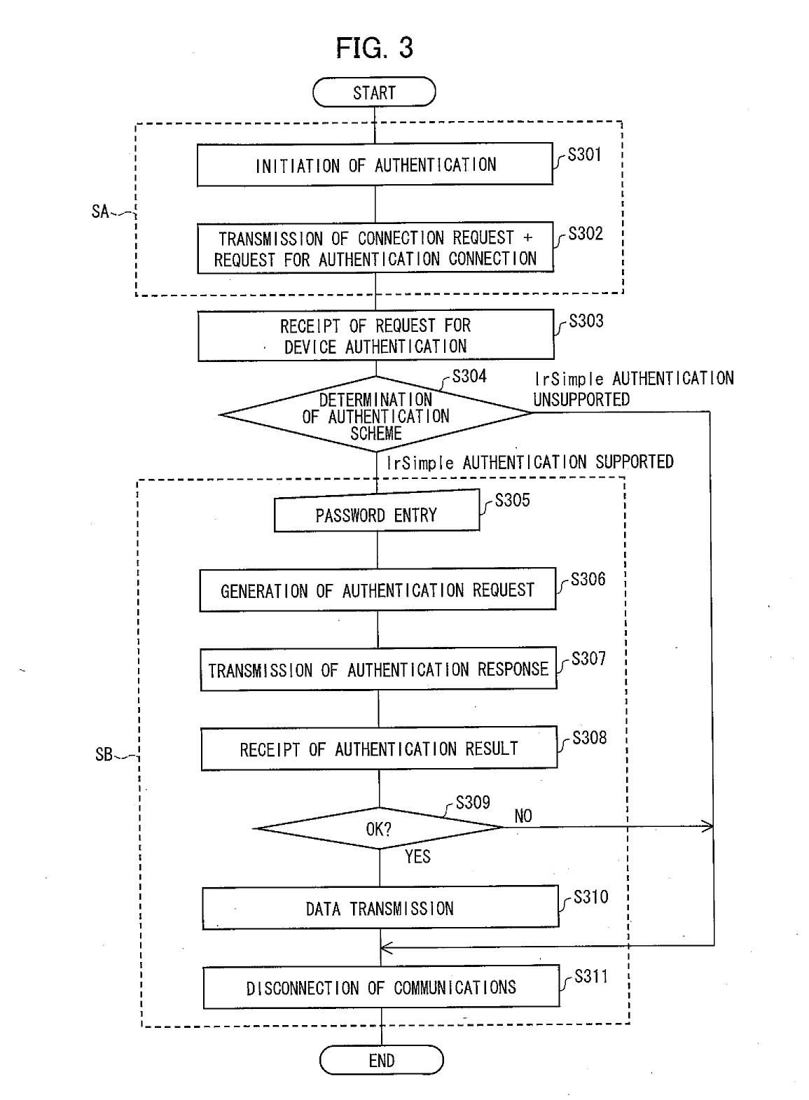

FIG. 3 is a flowchart illustrating the operation of the communications device when performing data transmission involving authentication in accordance with the IrSimple communications protocol.

In FIG. 3,

(1) A user of the communications device 100 gives an instruction via the input section 110 the communications device 100 to perform data transmission. The communications device 100 initiates an authentication operation in accordance with the IrSimple communications protocol (S301).

(2) In response to the instruction, the connecting section 141a of the IrSimple controlling section 141 of the communications device 100 transmits a connection request with a request for authentication connection, to the communications device 200 via the communicating section 150 (S302). Hereafter, the steps S301 and the S302 are collectively referred to as a step SA (IrSimple connection/authentication process).

(3) The communicating section 150 of the communications device 100 receives a request for a device authentication from the communications device 200 (S303).

(4) The authentication section 141b of the IrSimple controlling section 141 determines the type of an authentication method of the communications device 200 (S304).

(5) If it is determined at S304 that the communications device 200 does not support the IrSimple authentication operation, the IrSimple controlling section 141 causes the disconnecting section 141d to disconnect the communications with the communications device 200 without obtaining data (S311), and terminates the operation. Note that this is the case where a device to communicate is the communications device 200B (see FIG. 1).

(6) Conversely, if it is determined at S304 that the communications device 200 supports the IrSimple authentication operation, the notification section 130 prompts the user through display, voice announcement, and/or the like to enter a password. Note that this is the case where a device to communicate is the communications device 200A (see FIG. 1).

(7) When the password has been entered into the input section 110 by a user (S305), the authentication section 141b of the IrSimple controlling section 141 generates an authentication response code based on the request for a device authentication, which request has been received at S303, and the password thus entered at S305 (S306).

(8) The authentication section 141b of the IrSimple controlling section 141 transmits the authentication response code thus generated to the communications device 200 via the communicating section 150 (S307).

(9) The communicating section 150 receives an authentication result from the communications device 200 (S308).

(10) The authentication section 141b of the IrSimple controlling section 141 determines whether or not the authentication result is successful (S309).

(11) When the authentication with the communications device 200 is determined to be successful at S309 (YES at S309), the data transfer section 141c of the IrSimple controlling section 141 performs data transmission (S310).

(12) After the completion of the data transmission, the disconnection section 141d of the IrSimple controlling section 141 disconnects the communications with the communications device 200 (S311) and terminates the operation.

(13) Conversely, when the authentication with the communications device 200 is determined to be unsuccessful at S309 (NO at S309), the IrSimple controlling section 141 causes the disconnecting section 141d to disconnect the communications with the communications device 200 without obtaining data (S311), and terminates the operation.

Hereafter, the steps S305 to S311 are collectively referred to as a step SB (IrSimple authentication/data transmission process).

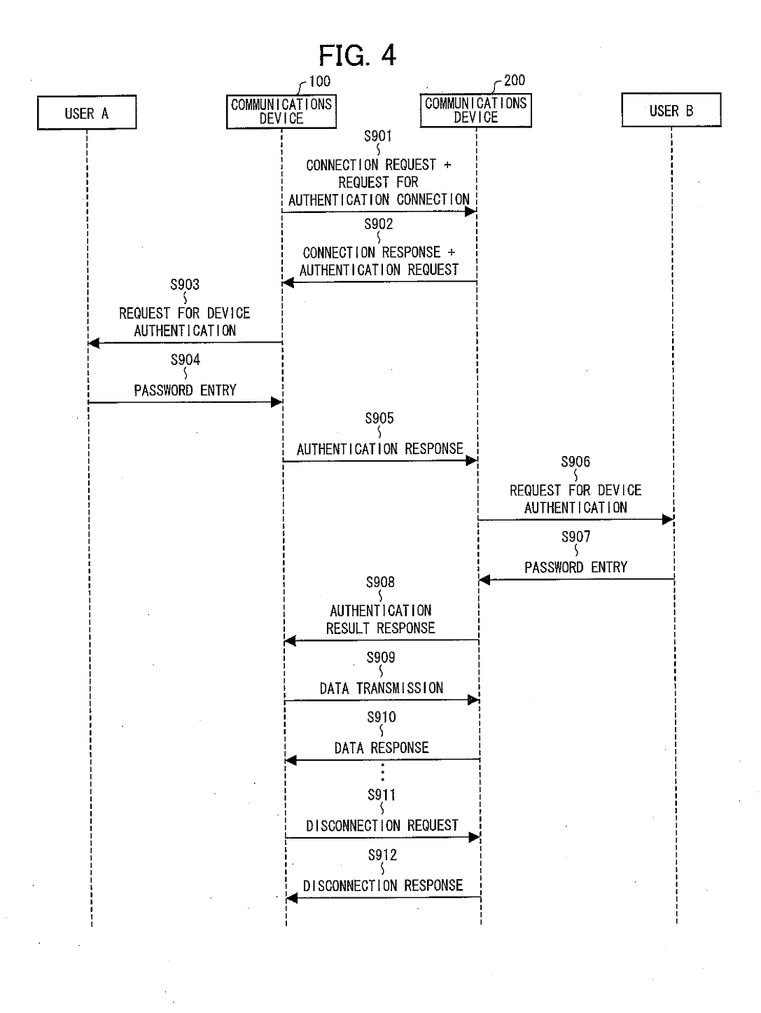

FIG. 4 is a sequence diagram illustrating one example of a basic sequence involving authentication in accordance with the IrSimple communications protocol.

In FIG. 4,

(1) In a situation that the communications devices 100 and 200 can communicate with each other, the connecting section 141a of the IrSimple controlling section 141 of the communications device 100 transmits to the communications device 200 a connection request with a request for authentication connection, in order to perform data transmission to the communications device 200 (S901).

(2) The communications device 200 generates authentication request information based on a terminal-specific value such as a manufacturing number and transmits the authentication request information to the communications device 100 (S902).

(3) When the authentication request information is received by the authentication section 141b of the IrSimple controlling section 141 of the communications device 100, the notification section 130 requests a user A who operates the communications device 100 for device authentication (S903).

(4) The user A enters a password, for example, four-digit numeral, to the communications device 100 via the input section 110 thereof (S904).

(5) The authentication section 141b of the IrSimple controlling section 141 of the communications device 100 generates authentication response information based on a value thus entered and transmits the authentication response information to the communications device 200 (S905).

(6) The communications device 200 presents a user B who operates the communications device 200 a request for a device authentication (S906).

(7) The user B enters to the communications device 200 the same numeral as the four-digit numeral entered to the communications device 100 by the user A (S907). The communications device 200 generates authentication information based on a value thus entered.

(8) The communications device 200 compares the authentication response information received from the communications device 100 with the authentication information generated based on the value entered by the user B. The communications device 200 transmits to the communications device 100 a comparison result as an authentication result response (S908).

(9) The authentication section 141b of the IrSimple controlling section 141 of the communications device 100 receives the authentication result response. When an authentication completion notification is “OK,” the data transfer section 141c initiates data transmission (S909).

(10) After S908, data transmission (S909) and data response (S910) are alternatively repeated the number of times required for data transfer. When data transfer is completed, the disconnecting section 141d of the IrSimple controlling section 141 of the communications device 100 transmits a disconnection request to the communications device 200 (S911).

(11) The communications device 200 receives the disconnection request and transmits to the communications device 100 a disconnection response (S912).

(12) The communications device 200 receives the disconnection response and terminates the communications (S912).

The user A and the user B may be the identical user.

Second, with reference to FIGS. 5, 6, and 2, the following describes the operation of the communications device 100, which operation is performed only in accordance with the IrDA communications protocol (second protocol). This operation is basically the same as the conventional operation performed in accordance with the IrDA communications protocol. As for the arrangement of the communications device 100, FIG. 1 is referred to as necessary.

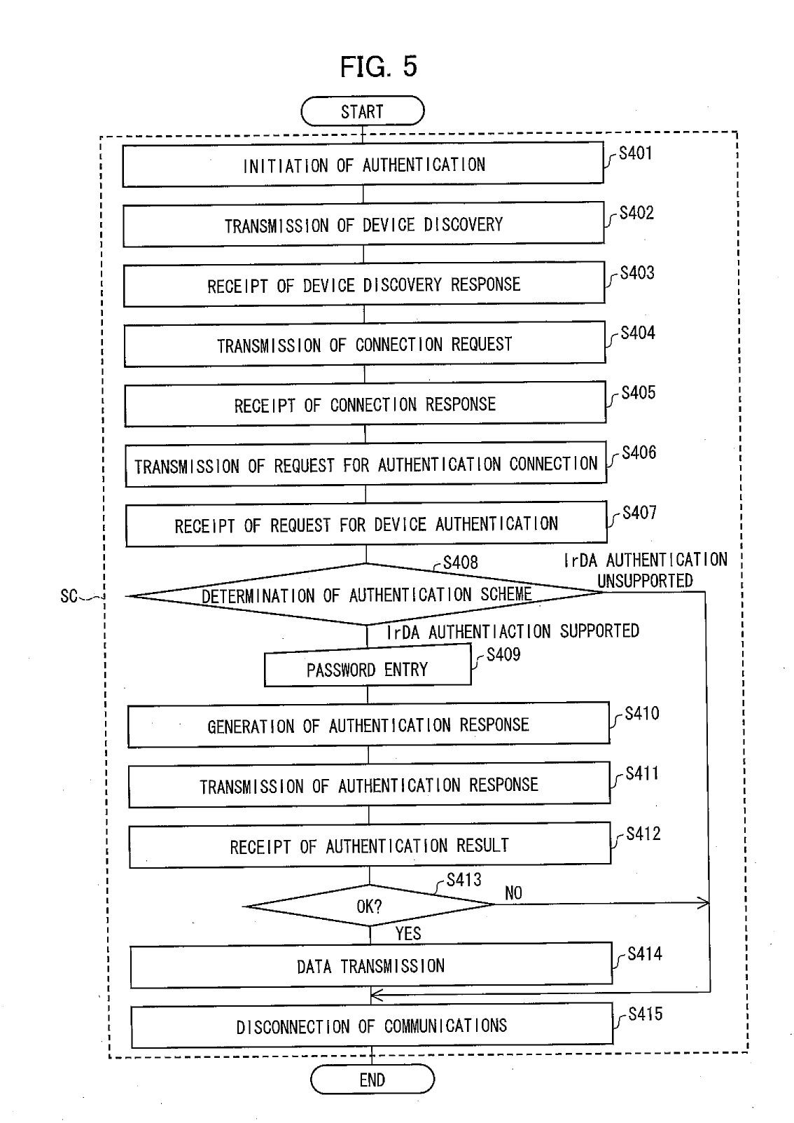

FIG. 5 is a flowchart illustrating the operation of the communications device when performing data transmission involving authentication in accordance with the IrDA communications protocol.

In FIG. 5,

(1) A user of the communications device 100 gives an instruction via the input section 110 the communications device 100 to perform data transmission. The communications device 100 initiates an authentication operation in accordance with the IrDA communications protocol (S401).

(2) In response to the instruction, the connecting section 142a of the IrDA controlling section 142 of the communications device 100 transmits via the communicating section 150 a device discovery to the communications device 200 (S402).

(3) The communicating section 150 of the communications device 100 receives a device discovery response from the communications device 200 (S403).

(4) The connecting section 142a of the IrDA controlling section 142 of the communications device 100 transmits a connection request to the communications device 200 via the communicating section 150 (S404).

(5) The communicating section 150 of the communications device 100 receives a connection response from the communications device 200 (S405).

(6) The authentication section 142b of the IrDA controlling section 142 of the communications device 100 transmits a request for authentication connection to the communications device 200 via the communicating section 150 (S406).

(7) The communicating section 150 of the communications device 100 receives a request for a device authentication from the communications device 200 (S407).

(8) The authentication section 142b of the IrDA controlling section 142 of the communications device 100 determines based on a result of authentication connection whether or not the communications device 200 supports the IrDA authentication operation (S408).

(9) When it is determined at S408 that the communications device 200 does not support the IrDA authentication operation, the IrDA controlling section 142 causes the disconnecting section 142d to disconnect the communications with the communications device 200 without performing data transmission (S415), and terminates the operation.

(10) Conversely, when it is determined at S408 that the communications device 200 supports the IrDA authentication operation, the notification section 130 of the communications device 100 prompts the user through display, voice announcement, and/or the like to enter a password.

(11) When the password is entered by the user A via the input section 110 (S409), the authentication section 142b of the IrDA controlling section 142 generates an authentication response code based on the request for a device authentication, which request has been received at S407, and the password thus entered at S409 (S410).

(12) The authentication section 142b of the IrDA controlling section 142 transmits the authentication response code thus generated to the communications device 200 via the communicating section 150 (S411).

(13) The communicating section 150 of the communications device 100 receives an authentication result from the communications device 200 (S412).

(14) The authentication section 142b of the IrDA controlling section 142 determines based on the authentication result whether or not the authentication is successful (S413).

(15) When the authentication with the communications device 200 is determined to be successful at S413 (YES at S413), the data transfer section 142c of the IrDA controlling section 142 performs data transmission (S414).

(16) After the data transmission is completed by the data transfer section 142c, the IrDA controlling section 142 causes the disconnection section 142d to disconnect the communications with the communications device 200 (S415) and to terminate the operation.

(17) Conversely, when the authentication with the communications device 200 is determined to be unsuccessful at S413 (NO at S413), the IrDA controlling section 142 of the communications device 100 causes the disconnecting section 142d to disconnect the communications with the communications device 200 without obtaining data (S415), and terminates the operation.

Hereafter, the steps S401 to S415 are collectively referred to as a step SC (IrDA connection/authentication/data transmission process).

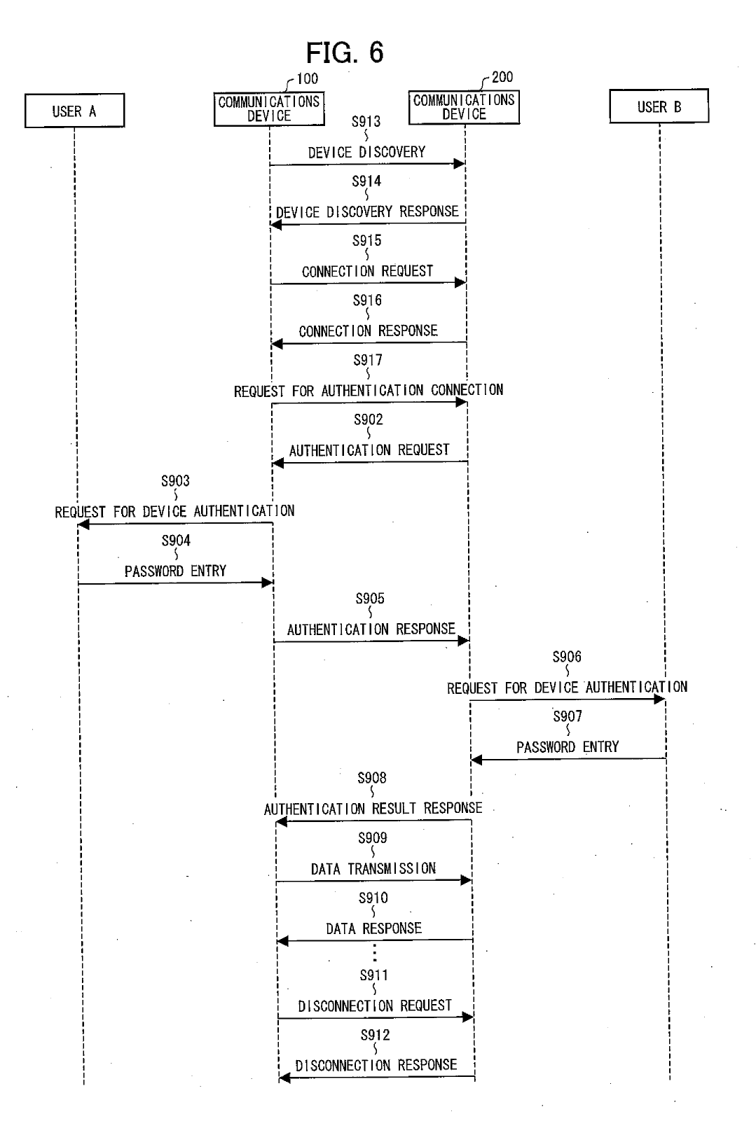

FIG. 6 is a sequence diagram illustrating one example of a basic sequence involving authentication in accordance with the IrDA communications protocol.

In FIG. 6,

(1) In a situation that the communications devices 100 and 200 can communicate with each other, the connecting section 142a of the communications device 100 transmits to the communications device 200 a device discovery for recognizing a device to communicate (S913).

(2) The communications device 200 transmits to the communications device 100 a device discovery response (S914).

(3) The connecting section 142a of the communications device 100 transmits to the communications device 200 a connection request in order to perform data transmission (S915).

(4) The communications device 200 transmits a connection response to the communications device 100 (S916).

(5) The authentication section 142b of the communications device 100 transmits a request for authentication connection to the communications device 200 (S917).

The following process of transmitting data is performed in the same manner as the IrSimple authentication operation, which has been described above with reference to FIG. 4.

The user A and the user B may be the identical user.

[Arrangement Examples]

The following describes a characteristic operation of the communications device 100 of the present embodiment. Specifically, the following describes the IrDA device authentication operation performed automatically or under the instruction from the user after the communications device 100 has failed in the IrSimple device authentication and disconnected the IrSimple communications since the communications device 200, which is a device to communicate, does not support the IrSimple authentication operation although being IrSimple compliant.

First, the following describes Arrangement Example 1, which is an arrangement in which the IrSimple scheme is automatically switched to the IrDA scheme.

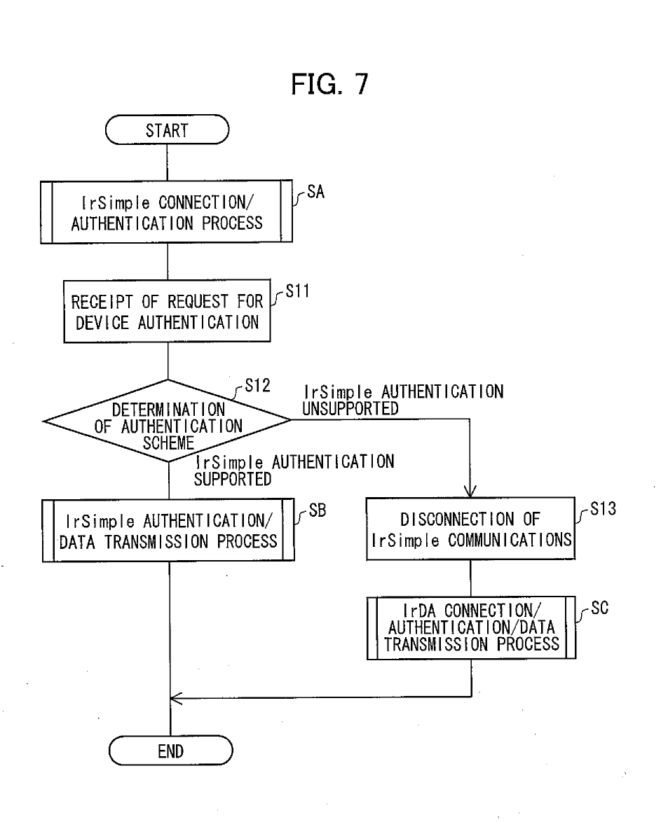

FIG. 7 is a flowchart illustrating processes for automatically switching to the IrDA scheme after the communications device 100 has failed in the IrSimple device authentication.

In FIG. 7,

(1) The communications device 100 performs the operations from the initiation of authentication to the receipt of an authentication request, through the communications with the communications device 200. These operations are made in the step SA illustrated in FIG. 3 (SA: IrSimple connection/authentication process; the first authentication step).

(2) The communicating section 150 of the communications device 100 receives a request for a device authentication from the communications device 200 (S11).

(3) The authentication section 141b of the IrSimple controlling section 141 of the communications device 100 determines the type of a scheme of communications between the communications devices 100 and 200 (S12).

(4) When the authentication section 141b of the IrSimple controlling section 141 of the communications device 100 determines that the communications device 200 supports the IrSimple authentication operation, the authentication section 141b transmits to the communications device 200 an authentication response generated based on an authentication password, and then, the data transfer section 141c performs data transmission. These operations are made in the step SB illustrated in FIG. 3 (SB: IrSimple authentication/data transmission process). Note that this is the case where a device to communicate is the communications device 200A (see FIG. 1).

(5) Conversely, when the authentication section 141b determines that the communications device 200 does not support the IrSimple authentication operation, the protocol switching section 143 switches the IrSimple protocol to the IrDA protocol. Specifically, under control of the protocol switching section 143, the disconnecting section 141d of the IrSimple controlling section 141 disconnects the IrSimple communications (S13). Then, without the instruction from the user, (i) the connecting section 142a establishes a connection with the communications device 200, (ii) the authentication section 142b performs authentication, (iii) the data transfer section 142c performs data transfer to the communications device 200, and (iv) the disconnecting section 142d disconnects the communications from the communications device 200. These operations are made in the step SC illustrated in FIG. 5 (SC: IrDA connection/authentication/data transmission process; the second connecting step; the second authentication step). Note that this is the case where a device to communicate is the communications device 200B (see FIG. 1). A method of disconnecting communications (S13) is described later.

As illustrated in the flowchart of FIG. 7, switching to the IrDA scheme is automatically performed after an unsuccessful device authentication of the IrSimple scheme. This allows the communications device 100 to make an attempt to perform the IrDA device authentication immediately after an unsuccessful authentication in accordance with the IrSimple communications protocol. Therefore, a single instruction given by a user to perform data transmission allows for IrSimple or IrDA data transmission. This reduces the number of operations which a user must perform and accordingly improves convenience of a communications device.

The communications devices 100 and 200 may be arranged such that the function of automatically performing the IrDA authentication operation is cancelled by user's operation to change the setting of the device.

Second, the following describes Arrangement Example 2, which is an arrangement in which switching from the IrSimple scheme to the IrDA scheme is performed under the instruction from a user.

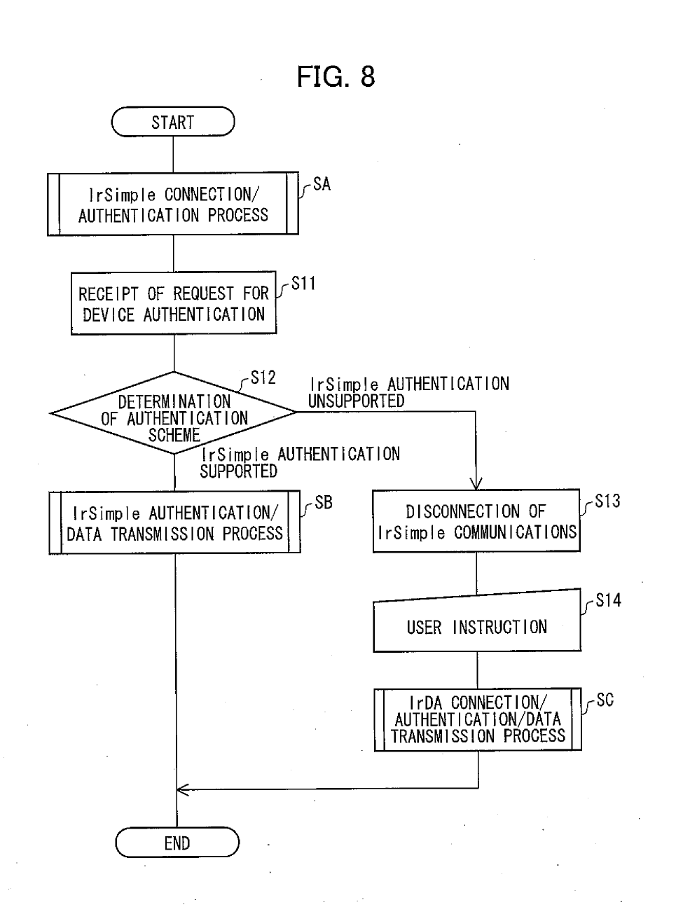

FIG. 8 is a flowchart illustrating processes for switching to the IrDA scheme under the instruction from the user, after the communications device 100 failed in the IrSimple device authentication. The flowchart of FIG. 8 is the same as the flowchart of FIG. 7 except the step S14.

In FIG. 8,

(1) The communications device 100 performs operations from the initiation of authentication to the receipt of an authentication request, between the communications devices 100 and 200 These operations are made in the step SA illustrated in FIG. 3 (SA: IrSimple connection/authentication process).

(2) The communicating section 150 of the communications device 100 receives a request for a device authentication from the communications device 200 (S11).

(3) The authentication section 141b of the IrSimple controlling section 141 of the communications device 100 determines the type of a scheme of communications between the communications devices 100 and 200 (S12).

(4) When the authentication section 141b of the IrSimple controlling section 141 of the communications device 100 determines that the communications device 200 supports the IrSimple authentication operation, the authentication section 141b transmits to the communications device 200 an authentication response generated based on an authentication password, and then, the data transfer section 141c performs data transmission. These operations are made in the step SB illustrated in FIG. 3 (SB: IrSimple authentication/data transmission process). Note that this is the case where a device to communicate is the communications device 200A (see FIG. 1).

(5) Conversely, when the authentication section 141b determines that the communications device 200 does not support the IrSimple authentication operation, the protocol switching section 143 switches the IrSimple protocol to the IrDA protocol. Specifically, under control of the protocol switching section 143, the disconnecting section 141d disconnects the IrSimple communications (S13). The notification section 13 then prompts the user A of the communications device 100 through display, voice announcement, and/or the like to perform an instructive operation for initiating the IrDA authentication. Note that this is the case where a device to communicate is the communications device 200B (see FIG. 1). A method of disconnecting communications (S13) is described later.

(6) The user A instructs again the communications device 100 via the input section 110 to initiate the IrDA authentication (S14).

(7) In the communications device 100, (i) the connecting section 142a establishes a connection with the communications device 200, (ii) the authentication section 142b performs authentication, (iii) the data transfer section 142c performs data transmission to the communications device 200, and (iv) the disconnecting section 142d disconnects the communications from the communications device 200. These operations are made in the step SC illustrated in FIG. 5 (SC: IrDA connection/authentication/data transmission process).

As illustrated in the flowchart of FIG. 8, after an unsuccessful IrSimple device authentication, the user is prompted to decide whether or not to switch to the IrDA scheme, and switching to the IrDA scheme is performed under the instruction from the user. This allows the communications device 100 to make an attempt to perform the IrDA device authentication upon user's confirmation, without interruption, after an unsuccessful authentication in accordance with the IrSimple communications protocol. Therefore, a user can carry out data transmission of the IrDA scheme through a simple operation even if the initial device authentication is unsuccessful. This makes it possible for the user to save a complicated operation and accordingly improve convenience of a communications device.

The following describes the authentication scheme determining process (S12) illustrated in FIGS. 7 and 8.

The communications device 100 of the present embodiment determines by the following procedure whether or not the communications device 200, which is a device to communicate, supports the IrSimple authentication operation.

[A] The case when it is determined that the communications device 200 supports the IrSimple authentication

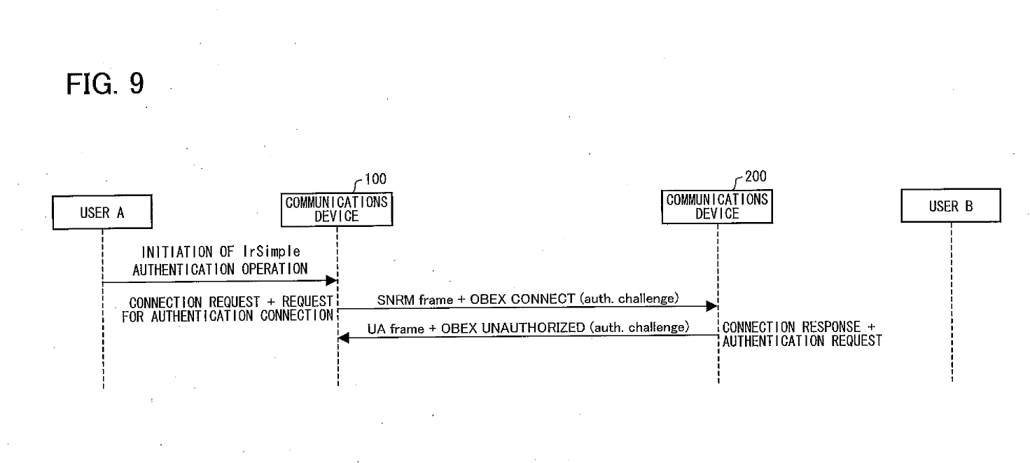

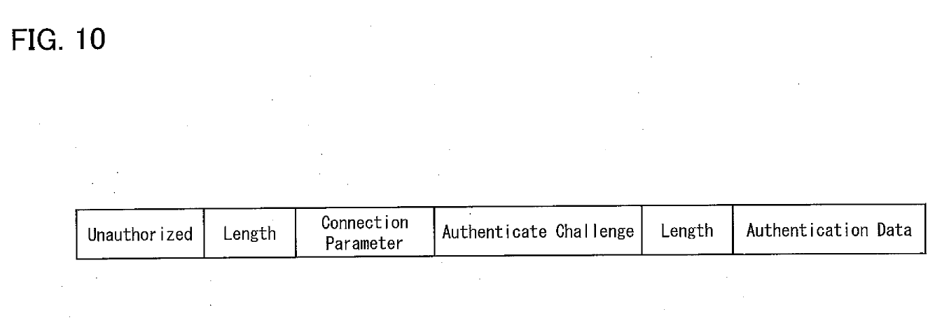

FIG. 9 is a sequence diagram illustrating one example of a basic sequence in which the communications device 100 determines that the communications device 200 supports the IrSimple authentication operation. FIG. 10 is an explanatory diagram illustrating one example of a data format of an UNAUTHORIZED response to the OBEX layer.

In FIG. 9,

(1) Upon initiation of the IrSimple authentication operation, the OBEX layer at the communications device 100, which is a transmitter, transmits a CONNECT command and an Authentication Challenge object utilizing an SNRM frame to the communications device 200, which is a receiver (connection request+request for authentication connection).

(2) If the communications device 200 supports the IrSimple authentication operation, the communications device 200 generates, based on a terminal-specific value such as a manufacturing number, another Authentication Challenge object, and transmits to the communications device 100 a UA frame that indicates the acceptance of the initiation of communications. The UA frame contains (i) an UNAUTHORIZED response (see FIG. 10), which is a response for notifying the OBEX layer of the incompletion of authentication and (ii) the Authentication Challenge object thus generated (connection response+authentication request).

(3) When receiving the authentication request from the communications device 200, the authentication section 141b of the communications device 100 determines that the communications device 200 supports the IrSimple authentication operation.

[B] The case when it is determined that the communications device 200 does not support the IrSimple authentication.

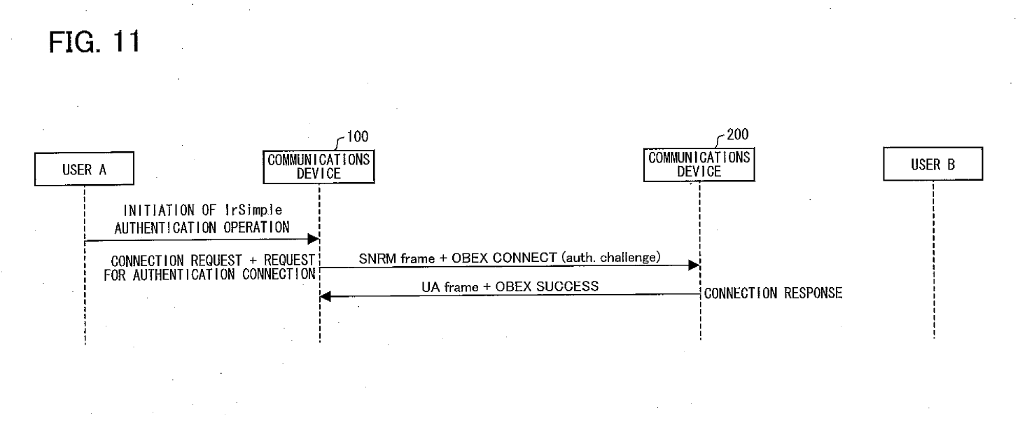

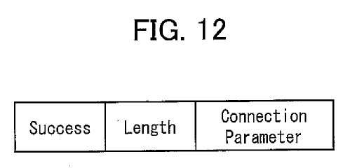

FIG. 11 is a sequence diagram illustrating one example of a basic sequence in which the communications device 100 determines that the communications device 200 does not support the IrSimple authentication operation although being IrSimple compliant. FIG. 12 is an explanatory diagram illustrating one example of a data format of a SUCCESS response to the OBEX layer.

In FIG. 11,

(1) Upon initiation of the IrSimple authentication operation, the OBEX layer at the communications device 100, which is a transmitter, transmits a CONNECT command and an Authentication Challenge object utilizing an SNRM frame to the communications device 200, which is a receiver (connection request+request for authentication connection), in the same manner as in FIG. 9.

(2) If the communications device 200 does not support the IrSimple authentication operation although being IrSimple compliant, the OBEX layer at the communications device 200 transmits to the communications device 100 a SUCCESS response (see FIG. 12) that indicates the acceptance of a connection without an authentication, utilizing a UA frame (connection response).

(3) When receiving the connection response from the communications device 200, the authentication section 141b of the communications device 100 determines that the communications device 200 does not support the IrSimple authentication operation although being IrSimple compliant.

Thus, when the authentication section 141b of the communications device 100 receives “connection response+authentication request” in response to “connection request+request for authentication connection, the authentication section 141b determines that the communications device 200 supports the IrSimple authentication operation. Conversely, when the authentication section 141b receives “connection response,” the authentication section 141b determines that the communications device 200 does not support the IrSimple authentication operation.

The following describes the process of disconnecting communications (S13) illustrated in FIGS. 7 and 8.

For the process of disconnecting communications (S13), there are the following two methods (a) and (b):

(a) The disconnecting section 141d causes the communicating section 150 to transmit a DISC (Disconnect) frame, which is a frame for requesting the termination of the IrSimple communications.

(b) Under the control of the disconnecting section 141d, the communications device 100 waits longer than a time limit (link disconnect time) within which the communications device 200 maintains communications when there is no response from the communications device 100, which is a device to communicate. The time limit is set by the communications device 200 in the IrSimple communications connection sequence. Time measurement of the time limit is performed by the timer 160.

According to the method (a), the IrSimple communications can be immediately terminated, which makes it possible to immediately proceed to the next step. Depending on a communications device 200, however, communications is not terminated by the method (a).

More specifically, device authentication is a sort of optional function in the IrSimple communications protocol. Therefore, when the communications device 200, which is a device to communicate, does not support device authentication, the communications device 200 is not provided with the optional function. An attempt to perform device authentication with such a communications device 200 may cause defects in the operation for communications. As a result, communications may not be terminated by the method (a).

According to the method (b), in contrast, waiting for an appropriate length of time is required until the end of the IrSimple communications. This requires a time before proceeding to the next step. However, according to the method (b), communications can be surely terminated, independently of whether or not the communications device 200 supports device authentication of the IrSimple scheme.

As a protocol used for data exchange between the communications devices 100 and 200 (data transfer sections 141c, 241c, and 242c), an object exchange protocol (OBEX) such as IrOBEX and IrMC can be used. The IrOBEX and the IrMC are used to transmit/receive telephone book information etc. between PDAs, PCs, or the like, by an infrared communication method. The communications devices 100 and 200 may be any devices as long as the devices have the data communications function of exchanging information such as a telephone book. Communications means corresponding to a communications scheme is not limited to a specific means.

A timing of password entry in the communications devices 100 and 200 is set to the timing described above or an earlier timing. For example, the timing may be set to be earlier than the initiation of authentication. Specifically, the entry of a password at the step S305 in FIG. 3 may be performed before the step S301 (i.e., the step SA). Also, the entry of a password at the step S408 in FIG. 5 may be performed before the step S301 (i.e., the step SA) or before the step S401 (i.e., the step SC).

As described above, the communications device 100 of the present embodiment is a communications device which performs an authentication with the communications device 200, which is a device to communicate, before information exchange therewith. The communications device 100 determines the type of a device authentication scheme supported by the communications device 200. When it is determined that the communications device 200 does not support the IrSimple device authentication, the communications device 100 disconnects the IrSimple communications. Then, the communications device 100 automatically performs the IrDA device authentication and performs information exchange. Alternatively, after disconnecting the IrSimple communications, the communications device 100 performs the IrDA device authentication under the instruction from the user and then performs information exchange.

The communications device 100 disconnects the IrSimple communications by transmitting a request for disconnection of the IrSimple communications, or, alternatively, by not responding to the communications device 200 for longer than a time limit (link disconnect time) within which the communications device 200 maintains a connection with the communications device 100 when there is no response from the communications device 100. The time limit is set by the communications device 200 in accordance with the IrSimple communication connection sequence.

This enables a user to obtain information automatically or through a simple operation, without interruption, only by performing an instructive operation for initiating information exchange. Therefore, since a user operation for data transfer can be simplified, convenience of communications can be improved.

The present invention may be arranged as below.

A transmitting device of the present invention may be arranged so as to be a transmitting device capable of communications, including authentication means for performing an authentication process, wherein, a connection process of the first communications scheme is performed at the data transmission involving an authentication process, and, when the authentication process is unsuccessful, another data transmission involving an authentication process is performed by communications means including a second communications scheme, which is different from the first communications scheme.

The transmitting device of the present invention may be arranged such that communications of the first communications scheme are infrared communications of an IrSimple scheme.

The transmitting device of the present invention may be arranged such that communications of the second communications scheme are infrared communications of an IrDA scheme.

The transmitting device may be arranged such that the communications means performs a disconnection process of the first communications scheme and performs a connection process and an authentication process according to the second communications scheme.

The transmitting device of the present invention may be arranged such that the communications means performs the disconnection process of the first communications scheme and, after transmitting means is performed by a user, performs a connection process and an authentication process according to the second communications scheme.

The transmitting device of the present invention may perform the disconnection process by transmitting a communications disconnection request of the first communications scheme.

The transmitting device of the present invention may perform the disconnection process by suspending transmission for an appropriate length of time.

The transmitting device of the present invention may transmit a notification for prompting a user to give instructions for retransmission.

Blocks of the communications device 100, especially the blocks of the IrSimple controlling section 141 and the protocol switching section 143 may be realized by hardware logic or software using a CPU as below.

That is, the communications device 100 includes a CPU (central processing unit) for executing commands of a control program for realizing the aforesaid functions, a ROM (read only memory) that stores the program, a RAM (random access memory) that develops the control program in executable form, and a storage device (storage medium), such as memory, that stores the control program and various types of data therein. With this arrangement, the object of the present invention is realized by a predetermined storage medium. The storage medium stores, in computer-readable manner, program codes (executable code program, intermediate code program, and source program) of the control program of the communications device 100, which is software for realizing the aforesaid functions. The storage medium is provided to the communications device 100. With this arrangement, the communications device 100 (alternatively, CPU or MPU) as a computer reads out and executes the program code stored in the storage medium provided.

The storage medium may be tape based, such as a magnetic tape or cassette tape; disc based, such as a magnetic disk including a floppy® disc and hard disk and optical disk including CD-ROM, MO, MD, DVD, and CD-R; card based, such as an IC card (including a memory card) and an optical card; or a semiconductor memory, such as a mask ROM, EPROM, EEPROM, and a flash ROM.

Further, the communications device 100 may be arranged so as to be connectable to a communications network so that the program code is supplied to the communications device 100 through the communications network. The communications network is not to be particularly limited. Examples of the communications network include the Internet, intranet, extranet, LAN, ISDN, VAN, CATV communications network, virtual private network, telephone network, mobile communications network, and satellite communications network. Further, a transmission medium that constitutes the communications network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared light, Bluetooth®, 802.11, HDR, mobile phone network, satellite connections, and terrestrial digital network. Note that the present invention can be also realized by the program codes in the form of a computer data signal embedded in a carrier wave which is embodied by electronic transmission.

The present invention is not limited to the description of the embodiments above, but may be altered by a skilled person within the scope of the claims. An embodiment based on a proper combination of technical means disclosed in different embodiments is encompassed in the technical scope of the present invention.

As described above, a communications device of the present invention is a communications device which performs communications in accordance with a communications protocol involving an authentication process, including; first connecting means for establishing a connection with a device at the other end in accordance with a first protocol; first authentication means for performing an authentication with the device at the other end through a process supported by the first protocol; second connecting means for establishing a connection with the device at the other end in accordance with a second protocol, which is different from the first protocol; second authentication means for performing an authentication with the device at the other end through a process supported by the second protocol; and protocol switching means for causing the second connecting means to initiate a connection and then causing the second authentication means to perform an authentication, when an authentication by the first authentication means is unsuccessful.

A communications method of the present invention is a communications method of a communications device which performs communications in accordance with a communications protocol involving an authentication process, including: a first authentication step of performing an authentication with a device at the other end through a process supported by a first protocol, after a connection with the device at the other end is initiated in accordance with the first protocol; a second connecting step of initiating a connection with the device at the other end in accordance with a second protocol, which is different from the first protocol, when an authentication by the first authentication step is unsuccessful; and a second authentication step of performing an authentication with the device at the other end through a process supported by the second protocol.

According to the arrangement, when the communications device established a connection with the other communications device in accordance with the first protocol and failed in an authentication with the other communications device, the communications device initiates a connection with the other communications device in accordance with the second protocol, which is different from the first protocol, and performs an authentication with the other communications device through a process supported by the second protocol.

Therefore, even if a device authentication in accordance with the first protocol is unsuccessful, the communications device can make an attempt to perform another device authentication in accordance with the second protocol, by switching the first protocol to the second protocol. For example, assume that a communications device supporting the IrSimple scheme as the first protocol and the IrDA scheme as the second protocol performs data transfer to the other communications device. In this case, even if the other communications device does not support a device authentication of the IrSimple scheme although being IrSimple and IrDA compliant, the communications device can perform communications with the other communications device by switching the protocol of the IrSimple scheme to the protocol of the IrDA scheme.

This enables a user of the communications device to exchange information with the other communications device, independently of an authentication scheme supported by the other communications device. This makes it possible to simplify a user operation for exchanging information and to improve convenience of communications.

A communications device of the present invention further includes: first disconnecting means for disconnecting a connection established by the first connecting means wherein, when the authentication by the first authentication means is unsuccessful, the protocol switching means causes the first disconnecting means to disconnect a connection, before causing the second connecting means to initiate a connection.

According to the arrangement, since a connection in accordance with the first protocol is disconnected before initiation of a connection in accordance with the second protocol, the connection in accordance with the second protocol can be more reliably established.

The communications device of the present invention is arranged such that, after causing the first disconnecting means to disconnect a connection, the protocol switching means obtains an entry by a user operation, which entry indicates permission of communications in accordance with the second protocol, and then causes the second connecting means to initiate a connection.

This arrangement makes it possible to request a user for a permission of switching to the second protocol and perform communications in accordance with the second protocol, before initiation of a connection in accordance with the second protocol. This makes it possible to switch to the second protocol and perform communications in accordance with the second protocol only when the user considers it necessity.

The communications device of the present invention is arranged such that the protocol switching means makes a notification for prompting a user to provide the entry.

According to the arrangement, a user can recognize that a device authentication in accordance with the first protocol is unsuccessful and can, as necessary, permit switching to the second protocol and performing communications in accordance with the second protocol.

The communications device of the present invention is arranged such that the first disconnecting means disconnects a connection by transmitting to the device at the other end a request for disconnecting communications of the first protocol.

According to the arrangement, when an authentication in accordance with the first protocol is unsuccessful, a connection in accordance with the first protocol can be immediately disconnected.

The communications device of the present invention is arranged such that the first disconnecting means disconnects a connection by not responding to the device at the other end for longer than a time limit within which the device at the other end maintains communications when the communications device does not respond to the device at the other end.

According to the arrangement, it is possible to reliably disconnect the connection in accordance with the first protocol by not responding for longer than a time limit. For example, even if a request for disconnecting communications of the first protocol does not function properly due to the status of the device at the other end regarding whether it is compliant with the first protocol, it is possible to reliably disconnect the connection in accordance with the first protocol.

The communications device can be realized with a computer. In this case, the present invention encompasses: a communications program for realizing with a computer the communications device by causing the computer to function as the means above; and a storage medium storing the communications program.

The communications device of the present invention can perform, automatically or through a simple operation, exchange information without interruption only by a user's instructive operation to initiate information exchange, independently of an authentication scheme supported by a device at the other end to communicate. Therefore, the communications device of the present invention can be widely employed as a communications device which performs an authentication before information exchange, and is especially suitable for an information terminal device, such as a portable phone and a PDA, which utilize wireless communications such as infrared communications.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A communications device which performs communications in accordance with a communications protocol involving an authentication process, comprising:
first connecting means for establishing a connection with a device at the other end in accordance with a first protocol;
first authentication means for performing an authentication with the device at the other end through a process supported by the first protocol;
second connecting means for establishing a connection with the device at the other end in accordance with a second protocol, which is different from the first protocol;
second authentication means for performing an authentication with the device at the other end through a process supported by the second protocol; and
protocol switching means for causing the second connecting means to initiate a connection and then causing the second authentication means to perform an authentication, when an authentication by the first authentication means is unsuccessful.

2. The communications device as set forth in claim 1, further comprising:
first disconnecting means for disconnecting the connection established by the first connecting means, wherein
when the authentication by the first authentication means is unsuccessful, the protocol switching means causes the first disconnecting means to disconnect the connection, before causing the second connecting means to initiate a connection.

3. The communications device as set forth in claim 2, wherein, after causing the first disconnecting means to disconnect the connection, the protocol switching means obtains an entry by a user operation, which entry indicates permission of communications in accordance with the second protocol, and then causes the second connecting means to initiate a connection.

4. The communications device as set forth in claim 3, wherein the protocol switching means makes a notification for prompting a user to provide the entry.

5. The communications device as set forth in claim 1, wherein the first disconnecting means disconnects the connection by transmitting to the device at the other end a request for disconnecting communications of the first protocol.

6. The communications device as set forth in claim 1, wherein the first disconnecting means disconnects a connection by not responding to the device at the other end for longer than a time limit within which the device at the other end maintains communications when the communications device does not respond to the device at the other end.

7. A communications method of a communications device which performs communications in accordance with a communications protocol involving an authentication process, comprising:
a first authentication step of performing an authentication with a device at the other end through a process supported by a first protocol, after a connection with the device at the other end is initiated in accordance with the first protocol;
a second connecting step of initiating a connection with the device at the other end in accordance with a second protocol, which is different from the first protocol, when an authentication by the first authentication step is unsuccessful; and
a second authentication step of performing an authentication with the device at the other end through a process supported by the second protocol.

8. A computer-readable storage medium storing a communications device control program, the communications device control program for causing a communications device to operate, which communications device performs communications in accordance with a communications protocol involving an authentication process,
the communications device control program causing a computer to function as:
first connecting means for establishing a connection with a device at the other end in accordance with a first protocol;
first authentication means for performing an authentication with the device at the other end through a process supported by the first protocol;
second connecting means for establishing a connection with the device at the other end in accordance with a second protocol, which is different from the first protocol;
second authentication means for performing an authentication with the device at the other end through a process supported by the second protocol; and
protocol switching means for causing the second connecting means to initiate a connection and then causing the second authentication means to perform an authentication, when an authentication by the first authentication means is unsuccessful.
